(19) United States
(12) Patent Application Publication
(10) Pub. No.: US 2006/0271839 A1
(43) Pub. Date: Nov. 30, 2006

(54) Connecting structured data sets

(76) Inventors: David Gottlieb, Scottsdale, AZ (US); Vinay Gupta, Scottsdale, AZ (US); Donald L. Goguen, Fountain Hills, AZ (US); Bodine Rye Blodgett, Scottsdale, AZ (US)

Correspondence Address: DRINKER BIDDLE & REATH (DC), 1500 K STREET, N.W., SUITE 1100, WASHINGTON, DC, 20005-1209, US

(21) Appl. No.: 11/439,173

(22) Filed: May 24, 2006

Related U.S. Application Data
(60) Provisional application No. 60/683,805, filed on May 24, 2005.

(51) Int. Cl. G06F 17/00; G06F 15/00

(52) U.S. Cl. 715/501.1; 715/513

(57) ABSTRACT

A method and computer device for connecting structured documents stored on a source computer to structured documents stored on a target computer. The method identifies links in the structured documents on the source computer and linkable elements in the structured documents on the target computer. Each link on the source computer points to a linkable element on the target computer. The method transmits the links from the source computer to the target computer and associates each link with one of the linkable elements. The method determines changes to the links in the structured documents on the source computer based on changes to the structured documents on the target computer. The method transmits the link changes to the source computer which updates the links based on the link changes.

### CROSS-REFERENCE TO A RELATED APPLICATION

This application for letters patent is related to and incorporates by reference provisional application for Ser. No. 60/683,805, titled “Connecting Structured Document Sets,” and filed in the United States Patent and Trademark Office on May 24, 2005.

### FIELD OF THE INVENTION

The present invention relates, in general, to processing structured documents. In particular, the present invention is a process for connecting the links in structured documents on a source computer to the linkable elements in structured documents on a target computer.

### BACKGROUND OF THE INVENTION

The number of documents available on the Internet has risen rapidly since its inception. Taking advantage of protocols such as hypertext linking in the HTML language, many of these documents link to other documents. Frequently, these links are from one document on a website to another document on the same website. It is not uncommon, however, for documents on one website to link to documents on a different website.

Although hypertext linking is a valuable tool, it has inherent limitations. Since the communication is “one way”, that is, the target document knows virtually nothing about the requestor, the requestor has no easy way of telling when the target document has changed or has been removed from the Internet. This results in either “broken links” where the requested document cannot be found, or “erroneous links” where the link succeeds but displays a document, or part of a document, that differs from what was originally intended. One common example of this is using a search engine to locate a set of links to documents that are relevant to a certain subject, where the link to one of the documents in the set includes content that has changed and is no longer relevant to the searched subject.

The problem described above is exacerbated in “structured documents”. A structured document is one that is divided into parts that can be conveniently referenced. For example, government laws and regulations are commonly structured, being divided into such elements as numbered sections and lettered paragraphs. Thus, a reference to section 417(a)(4) of a particular law is actually a reference to section 417, paragraph (a), subparagraph (4) of the particular law. Hypertext links to such structured documents often specify the particular section and paragraph intended as the target, but if the document has been revised since the link was written, the section may have been deleted, or the paragraphs renumbered. In these cases, the link will not be able to behave as desired. Furthermore, the person who wrote the link will generally not be aware of the change in the target document, and so will not make the necessary correction to it. In a complex and dynamic structured document such as the United States Code of Federal Regulations, the compilation of United States federal regulations that is maintained by the federal government, the number of these broken or erroneous links can be quite large.

Methods to assure that hypertext links remain valid take two forms. The first method scans the source documents, finds all hypertext links in those documents, and attempts to link to these targets. If the link fails, a user is notified about the potential “broken link”. This method will typically find broken links but it cannot find erroneous links because the method will report that something has been located and assume success. The second method to assure that the hypertext links are valid is manual review by a human being. Even though this second method is potentially highly accurate, it may be prohibitively time consuming if the source documents are complex, very dynamic, and/or have numerous links.

A second problem results in “incomplete” links in the source documents when new documents are added to the target website or when existing documents are expanded or modified. Referring again to the United States Code of Federal Regulations example, this problem occurs when a new law is passed or when an old law is amended to include additional provisions, and results in links in the source documents that, while possibly valid, may now be “incomplete” links. For example, one of the source documents may instruct potential teachers that the application process for obtaining a teaching license includes a list four requirements, each requirement containing a hypertext link to a section and paragraph in a government regulation. If a revision to the application process adds new paragraph (i.e., a fifth requirement), the author of the source document has no easy way to know that he must also revise the source document. Again, generally, the only procedure to minimize incomplete links is manual review by a human being, a time consuming task.

### SUMMARY OF THE INVENTION

A method and computer device for connecting structured documents stored on a source computer to structured documents stored on a target computer. In one exemplary embodiment, the method identifies links in the structured documents on the source computer where each link points to a linkable element in the structured documents on the target computer. The method transmits the links to the target computer and receives link changes from the target computer. The method updates the links based on the link changes.

In another exemplary embodiment, the method receives links from the source computer where each link in the structured documents on the source computer points to a linkable element in the structured documents on the target computer. The method identifies linkable elements in the structured document on the target computer. The method associates each link with one of the linkable elements. The method determines link changes based on a change to the structured documents on the target computer. The method transmits the link changes to the source computer.

### BRIEF DESCRIPTION OF THE DRAWINGS

FIG. 1 is a block diagram that illustrates the hardware and software components comprising an exemplary embodiment of a system for connecting structured document sets;

FIG. 2 is a flow diagram that illustrates an exemplary embodiment of a method for connecting structured documents in a source document set 210 to structured documents in a target document set 220;

FIG. 3A illustrates one exemplary embodiment of a structured set of documents;

FIG. 3B illustrates one exemplary embodiment of the structure of a single document in a structured set of documents;

FIG. 4 is a flow diagram that further illustrates the method for connecting structured document sets shown in FIG. 2 to illustrate one exemplary embodiment of the source document set 210 and link program 116;

FIG. 5 is a flow diagram that further illustrates the method for connecting structured document sets shown in FIG. 2 to illustrate one exemplary embodiment of the target document set 220 and linkable elements program 127; and

FIG. 6 is a flow diagram that further illustrates the method for connecting structured document sets shown in FIG. 2 to illustrate one exemplary embodiment of link connection program 126.

### DETAILED DESCRIPTION OF THE INVENTION

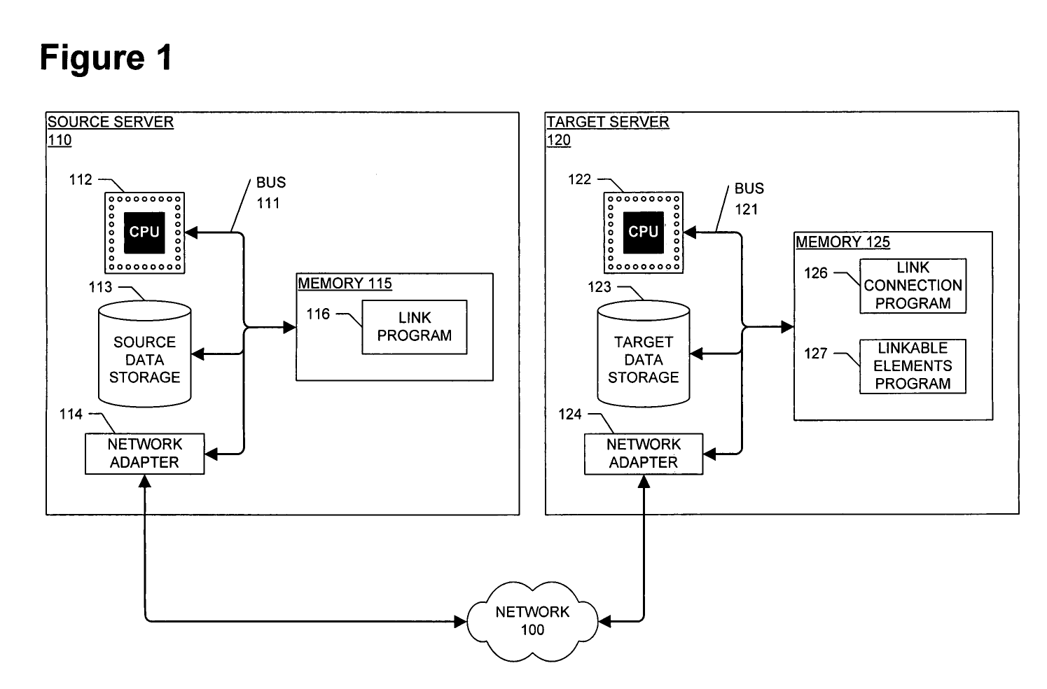

FIG. 1 is a block diagram that illustrates the hardware and software components comprising an exemplary embodiment of a system for connecting structured document sets. The system for connecting structured document sets comprises a source server 110, a target server 120, and a network 100.

The source server 110 shown in FIG. 1 is a general-purpose computer. Bus 111 is a communication medium that connects a central processor unit (CPU) 112, source data storage 113, and a network adapter 114 to a memory 115. The network adapter 114 also connects to a network 100 and is the mechanism that facilitates the passage of network traffic between the system for connecting structured document sets and the network 100. The CPU 112 performs the disclosed methods by executing the sequences of operational instructions that comprise each computer program resident in, or operative on, the memory 115. In one embodiment, the source server 110 includes a web server that allows other computers on the network 100 to access documents stored on the source server 110.

The source data storage 113 shown in FIG. 1 is an internal data storage device. It is to be understood however, that in another embodiment the source data storage 113 may be external to the source server 110 and accessible via a network connection. The system for connecting structured document sets also contemplates distributing the source data storage 113 over multiple storage devices to suit efficiency, performance, backup, and data warehousing requirements. In one embodiment, the source data storage 113 utilizes a relational database management system such as Oracle Database 10 g by Oracle™. In another embodiment, the source data storage 113 utilizes a different database management tool that is either homegrown or publicly available and traded. In yet another embodiment, the source data storage 113 utilizes an object-oriented database management system such as Perst, open source software provided by McObject.

In one embodiment, the configuration of the memory 115 in the source server 110 includes, in addition to the necessary operating system and application programs (not shown), a link program 116. The programs that run in the memory 115 store intermediate results in the memory 115 and transmit final results via the bus 111 for storage in the source data storage 113. It is to be understood that in another embodiment the configuration of the memory 115 may not simultaneously include these programs. The CPU 112 coordinates loading a program when it is needed, storing intermediate results, transferring data from one program to another, and unloading the program when it is no longer needed.

The target server 120 shown in FIG. 1 is a general-purpose computer. Bus 121 is a communication medium that connects a central processor unit (CPU) 122, target data storage 123, and a network adapter 124 to a memory 125. The network adapter 124 also connects to the network 100 and is the mechanism that facilitates the passage of network traffic between the system for connecting structured document sets and the network 100. The CPU 122 performs the disclosed methods by executing the sequences of operational instructions that comprise each computer program resident in, or operative on, the memory 125. In one embodiment, the target server 120 includes a web server that allows other computers on the network 100 to access documents stored on the target server 120.

The target data storage 123 shown in FIG. 1 is an internal data storage device. It is to be understood however, that in another embodiment the target data storage 123 may be external to the target server 120 and accessible via a network connection. The system for connecting structured document sets also contemplates distributing the target data storage 123 over multiple storage devices to suit efficiency, performance, backup, and data warehousing requirements. In one embodiment, the target data storage 123 utilizes a relational database management system such as Oracle Database 10 g by Oracle™. In another embodiment, the target data storage 123 utilizes a different database management tool that is either homegrown or publicly available and traded. In yet another embodiment, the target data storage 123 utilizes an object-oriented database management system such as Perst, open source software provided by McObject.

In one embodiment, the configuration of the memory 125 in the target server 120 includes, in addition to the necessary operating system and application programs (not shown), a link connection program 126 and a linkable elements program 127. The programs that run in the memory 125 store intermediate results in the memory 125 and transmit final results via the bus 121 for storage in the target data storage 123. It is to be understood that in another embodiment the configuration of the memory 125 may not simultaneously include these programs. The CPU 122 coordinates loading a program when it is needed, storing intermediate results, transferring data from one program to another, and unloading the program when it is no longer needed.

The network 100 shown in FIG. 1, in an exemplary embodiment, is a public communication network but, the system for connecting structured document sets also contemplates the use of comparable network architectures. Comparable network architectures include the Public Switched Telephone Network (PSTN), a public packet-switched network carrying data and voice packets, a wireless network, and a private network. A wireless network includes a cellular network (e.g., a Time Division Multiple Access (TDMA) or Code Division Multiple Access (CDMA) network), a satellite network, and a wireless Local Area Network (LAN) (e.g., a wireless fidelity (Wi-Fi) network). A private network includes a LAN, a Personal Area Network (PAN) such as a Bluetooth network, a wireless LAN, a Virtual Private Network (VPN), an intranet, or an extranet. An intranet is a private communication network that provides an organization such as a corporation, with a secure means for trusted members of the organization to access the resources on the organization's network. In contrast, an extranet is a private communication network that provides an organization, such as a corporation, with a secure means for the organization to authorize non-members of the organization to access certain resources on the organization's network. The system also contemplates network architectures and protocols such as Ethernet, Token Ring, Systems Network Architecture, Internet Protocol, Transmission Control Protocol, User Datagram Protocol, Asynchronous Transfer Mode, and proprietary network protocols comparable to the Internet Protocol.

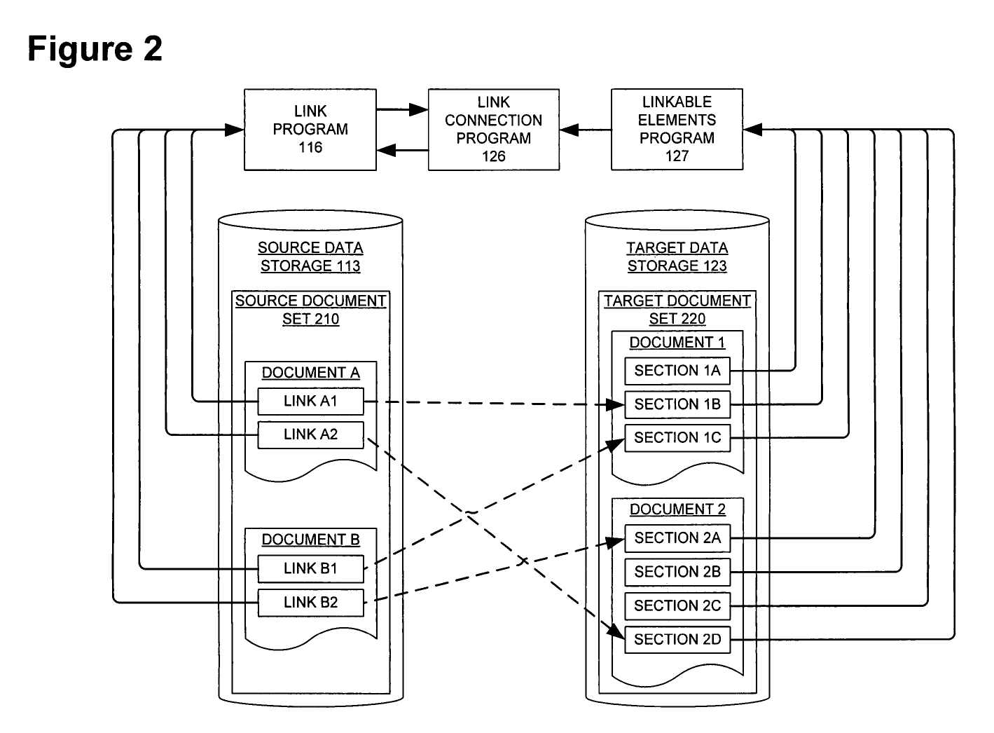

FIG. 2 is a flow diagram that illustrates an exemplary embodiment of a method for connecting structured documents in a source document set 210 to structured documents in a target document set 220. The source document set 210 includes two structured documents, document A and document B. Document A includes two hypertext links, link A1 and link A2, to sections in a structured document in the target document set 220. Document B includes two hypertext links, link B1 and link B2, to sections in a structured document in the target document set 220. The target document set 220 includes two structured documents, document 1 and document 2. Document 1 includes three sections, section 1A, section 1B and section 1C, which may be referenced by a hypertext link in a structured document in the source document set 210. Document 2 include four sections, section 2A, section 2B, section 2C and section 2D, which may be referenced by a hypertext link in a structured document in the source document set 210. The source document set 210 and the target document set 220 reside on separate servers that include a web server and are not both controlled by the same owner. Thus, without the connection that the invention provides, the source document set 210 and the target document set 220 would only have one-way connectivity (i.e., from the source document set 110 to the target document set 220) and the owner of the target document set 220 would be unaware of the nature and structure of the documents in the source document set 210.

As shown in FIG. 2, an embodiment of the method for connecting structured document sets includes three processes, link program 116, link connection program 126 and linkable elements program 127. In one exemplary embodiment, the link program 116, link connection program 126 and linkable elements program 127 are separate, independent processes. In other exemplary embodiments, the functions performed by the link program 116, link connection program 126 and linkable elements program 127 may be consolidated into fewer processes or divided into a greater number of processes.

The link program 116 is logically connected to the source document set 210. In one exemplary embodiment, the link program 116 is provided by the owner of the source document set 210. The link program 116 is aware of all of the links from the source document set 210 to the target document set 220. As shown in FIG. 2, the link program 116 is aware of links from link A1 in document A to section 1B in document 1, link A2 in document A to section 2D in document 2, link B1 in document B to section 1C in document 1, and link B2 in document B to section 2A in document 2. The link program 116 is also aware of changes and additions to the source document set 210, and is capable of communicating this link information to the link connection program 126.

The linkable elements program 127 is logically connected to the target document set 220. In one exemplary embodiment, the linkable elements program 127 is provided by the owner of the target document set 220. The linkable elements program 127 is aware of all the locations in the target document set 220 (i.e., “linkable elements”) to which links in the source document set 210 may refer. As shown in FIG. 2, the linkable elements program 127 is aware of section 1A in document 1, section 1B in document 1, section 1C in document 1, section 2A in document 2, section 2B in document 2, section 2C in document 2, and section 2D in document 2. The linkable elements program 127 is also aware of changes and additions to the target document set 220, and is capable of communicating this information to the link connection program 126.

The link connection program 126 logically connects the links in the source document set 210 (obtained from the link program 116) to the linkable elements in the target document set 220 and to the changes in the target document set 220 (obtained from the linkable elements program 127). The link connection program 126 is capable of providing feedback to the owner of the source document set 210, specifically information about changes in the target document set 220 that affect the source document set 210, as implied by the links in the source document set 210 to the linkable elements in the target document set 220.

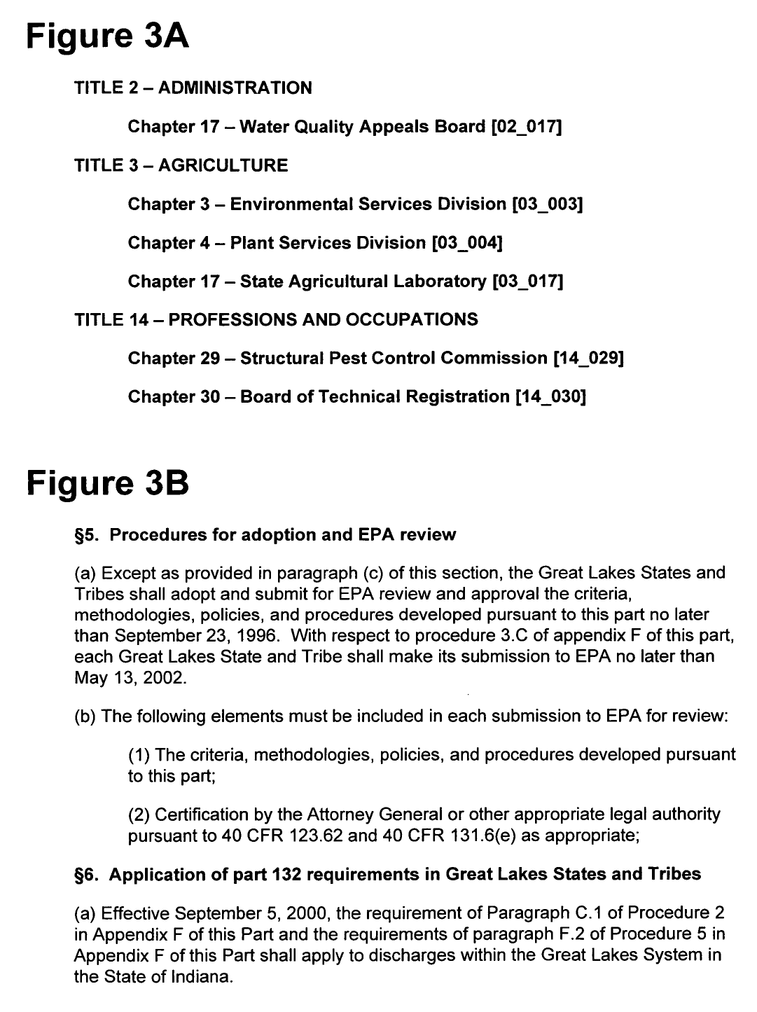

FIG. 3A illustrates one exemplary embodiment of a structured set of documents. FIG. 3A shows excerpts from the regulations for the state of Arizona. As shown in FIG. 3A, the six chapters (i.e., “Chapter 17—Water Quality Appeals Board [02_{—}017]”, “Chapter 3—Environmental Services Division [03_{—}003]”, “Chapter 4—Plant Services Division [03_{—}004]”, “Chapter 17—State Agricultural Laboratory [03_{—}017]”, “Chapter 29—Structural Pest Control Commission [14_{—}029]”, and “Chapter 30—Board of Technical Registration [14_{—}030]”) are the documents, and the three titles (i.e., “TITLE 2—ADMINISTRATION”, “TITLE 3—AGRICULTURE”, and “TITLE 14—PROFESSIONS AND OCCUPATIONS”) are the hierarchical structure elements used to organize the documents, but the three titles are not themselves documents. To qualify as a structured document set, there need be no more than one level of organization to the document. In FIG. 3A, the two levels are desirable because there are two chapter 17 documents (i.e., “Chapter 17—Water Quality Appeals Board [02_{—}017]” and “Chapter 17—State Agricultural Laboratory [03_{—}017]”), one each in “TITLE 2—ADMINISTRATION” and “TITLE 3—AGRICULTURE”. A distinguishable characteristic of a structured document set is that each document must have a unique identifier (i.e., “key”) that references the document within the structured document set. In one embodiment, the key consists of concatenated segments of numbers and/or letters. In FIG. 3A, a possible set of keys is shown in brackets to the right of each chapter description (i.e., “[02_{—}017]”, “[03_{—}003]”, “[03_{—}004]”, “[03_{—}017]”, “[14_{—}029]”, and “[14_{—}030]”).

FIG. 3B illustrates one exemplary embodiment of the structure of a single document in a structured set of documents. The present invention does not require the “internal” structure shown in FIG. 3B, but will take advantage of the internal structure if it is present in the documents. The exemplary document shown in FIG. 3B includes excerpts from the United States Code of Federal Regulations, Title 40, Part 132. This exemplary document in the document set of the United States Code of Federal Regulations. The exemplary document shows the structure within the document, (i.e., sections and paragraphs). The exemplary document includes two levels of paragraphs. Similar to a structured document set, the structure within a document requires that each structure element be referenced by a unique key. For example, as shown in FIG. 3B, one possible unique key for section 5 (i.e., “§ 5”) is “5”, and one possible key for the first paragraph under section 5 is “5(a)”.

The division of a universe of information into documents, and the subdivision of the documents into structure elements, is arbitrary. It is possible to consider the entire universe (structured document set) as a single document, with a more complex internal structure that first divides the single combined document into segments corresponding to what we previously called documents, and then subdivides each into the previous structure elements. In fact, a hypertext link must make use of both the document unique key and, if desired, the unique key to the structure element within the document (e.g., 40 C.F.R. 132.5(a)). The division of the document set first into documents and then into structure elements within each document is done only to conform to current general practice and style preference.

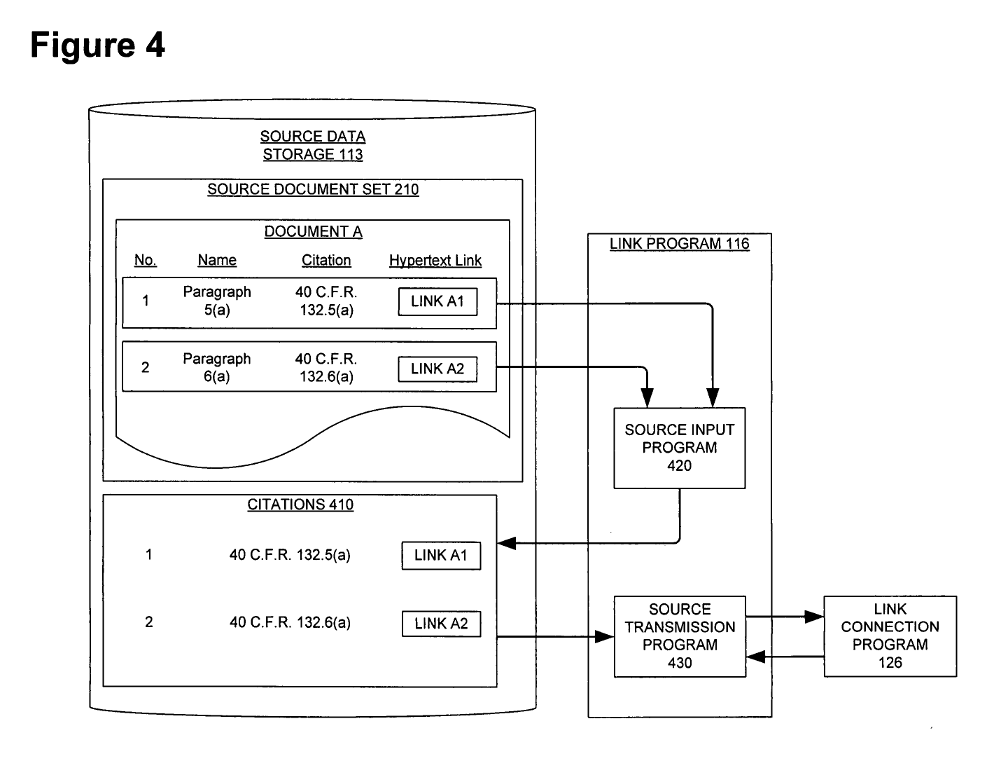

FIG. 4 is a flow diagram that further illustrates the method for connecting structured document sets shown in FIG. 2 to illustrate one exemplary embodiment of the source document set 210 and link program 116. The document A shown in FIG. 4 is a structured document. The internal structure of the document A is expanded to show its internal structure. The expanded document A is represented as a spreadsheet with two rows and four columns. The column heading for the first column is “No.”. Each row stores a unique key in the first column that corresponds to a structure element in the document A. In the exemplary embodiment shown in FIG. 4, the unique keys are the sequential integers “1” and “2”. The column heading for the second column is “Name”. Each row stores a textual description in the second column that describes the associated structure element in the document A. In the exemplary embodiment shown in FIG. 4, the names are “Paragraph 5(a)” and “Paragraph 6(a)”. The column heading for the third column is “Citation”. Each row stores a text citation in the third column that is associated with the structure element in the document A. In the exemplary embodiment shown in FIG. 4, the citations are “40 C.F.R. 132.5(a)” and “40 C.F.R. 132.6(a)”. The column heading for the fourth column is “Hypertext Link”. Each row stores a hypertext link in the fourth column that is a link to a document in the target document set that corresponds to the text citation. In the exemplary embodiment shown in FIG. 4, the links are link A1 and link A2.

The link program 116 includes a source input program 420 and a source transmission program 430. The source input program 420 obtains its input from the source document set 210, particularly the citation and hypertext link columns. The source input program 420 creates an electronically readable collection of the input data and stores the information in the citations 410 portion of the source data storage 113. In exemplary embodiments, the storing of the information is as a file on a hard disk drive or removable disk drive, a table in a relational database, an object in an object-oriented database, or in a memory device such as read-only memory (ROM), random access memory (RAM), flash memory, or the like. In another exemplary embodiment, the citations 410 portion of the source data storage 113 are resident in separate data storage devices. The source transmission program 430 accesses the information stored in the citations 410 portion of source data storage 113 as its input and, upon demand, transmits the accessed information to the link connection program 126.

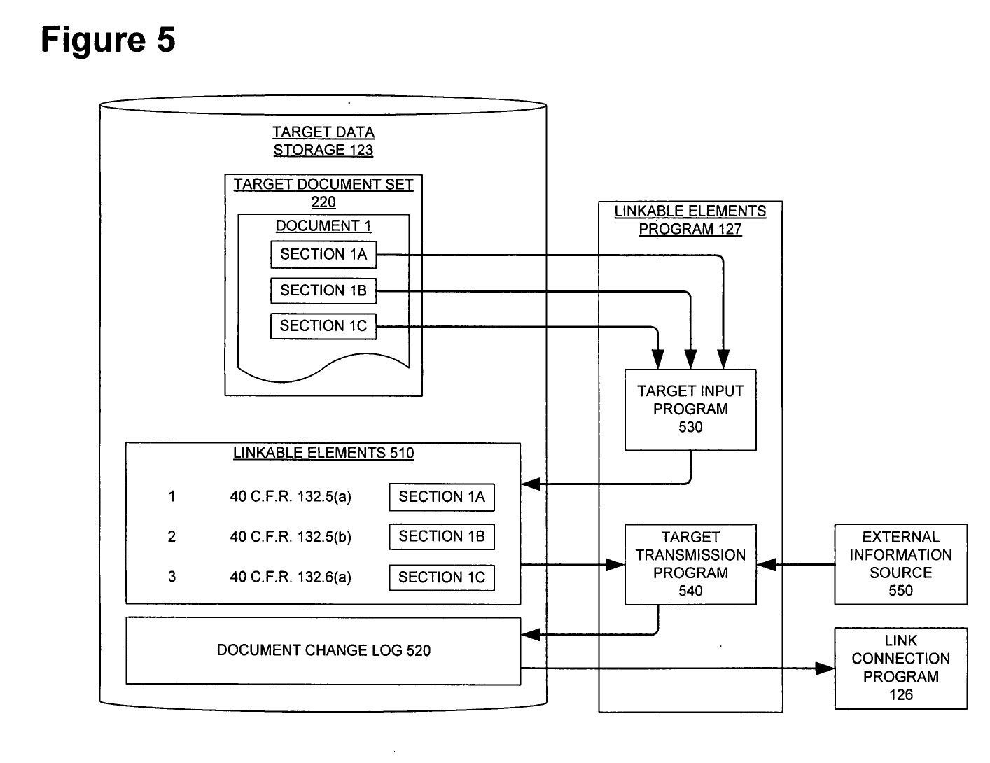

FIG. 5 is a flow diagram that further illustrates the method for connecting structured document sets shown in FIG. 2 to illustrate one exemplary embodiment of the target document set 220 and linkable elements program 127. The document 1 shown in FIG. 5 is a structured document. The internal structure of the document 1 includes three sections, section 1A, section 1B, and section 1C. Each section corresponds to a portion of the document 1 that includes text paragraphs, headings, and/or titles. The location of each section within the document 1 can also be located using a hypertext link from another document.

The linkable elements program 127 includes a target input program 530 and a target transmission program 540. The target input program 530 obtains its input from the target document set 220, particularly the linkable portions of the document 1, section 1A, section 1B, and section 1C. The target input program 530 creates an electronically readable collection of the input data and stores the information in the linkable elements 510 portion of the target data storage 123. In exemplary embodiments, the storing of the information is as a file on a hard disk drive or removable disk drive, a table in a relational database, an object in an object-oriented database, or in a memory device such as read-only memory (ROM), random access memory (RAM), flash memory, or the like. In another exemplary embodiment, the linkable elements 510 portion of the target data storage 113 are resident in separate data storage devices. The target transmission program 540 accesses the information stored in the linkable elements 510 portion of the target data storage 113 as its input. In another embodiment, the target transmission program 540 also derives input data from an external information source 550 to provide updated documents as they become available. The target transmission program 540 produces as output data a log of document changes that it writes to a document change log 520 portion of the target data storage 123. The log specifies the linkable elements (i.e., section 1A, section 1B, and section 1C) within the document 1 that have been added, changed, or deleted for each updated document. The document change log 520 portion of the target data storage 123 is available to the link connection program 126 upon demand. The connection to the link connection program 126 may be initiated either by the linkable elements program 127 or the link connection program 126. The data may be transferred in bulk (the entire log) or piecemeal, as requested by the link connection program 126. In another exemplary embodiment, the document change log 510 portion of the target data storage 123 are resident in separate data storage devices.

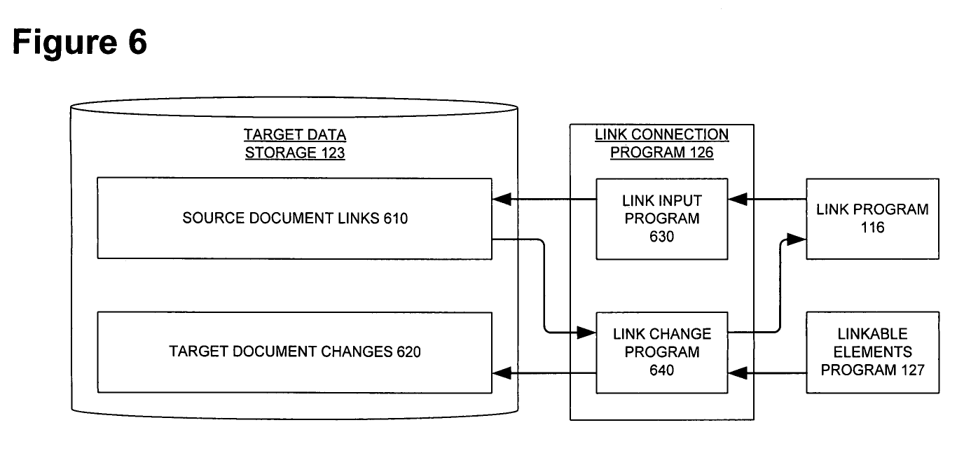

FIG. 6 is a flow diagram that further illustrates the method for connecting structured document sets shown in FIG. 2 to illustrate one exemplary embodiment of link connection program 126. The link connection program 126 includes a link input program 630 and a link change program 640.

The link input program 630 accepts input from the link program 116 in the form of a list of source document links (e.g., the data stored in the citations 410 portion of the source data storage 113, as shown in FIG. 4), transforms the list into an electronically readable collection, and stores the information in the source document links 610 portion of the target data storage 123. In exemplary embodiments, the storing of the information is as a file on a hard disk drive or removable disk drive, a table in a relational database, an object in an object-oriented database, or in a memory device such as read-only memory (ROM), random access memory (RAM), flash memory, or the like. In another exemplary embodiment, the source document links 610 portion of the target data storage 123 is resident in a separate data storage device.

The link change program 640 accesses the information stored in the source document links 610 portion of the target data storage 123 as one of its inputs. The link change program 640 obtains information about changes to the documents containing the target of these links from the linkable elements program 127 either by bulk uploading of this data and storing it in an electronically readable collection (as illustrated in the discussion of FIG. 5), or by requesting data for the individual links which the linkable elements program 127 then transmits to the link connection program 126. These inputs are combined in an electronically readable collection and stored in the target document changes 620 portion of the target data storage 123. In exemplary embodiments, the storing of the information is as a file on a hard disk drive or removable disk drive, a table in a relational database, an object in an object-oriented database, or in a memory device such as read-only memory (ROM), random access memory (RAM), flash memory, or the like. In one exemplary embodiment, each change stored in the target document changes 620 portion of the target data storage 123 includes: (i) the source document key and the structure element key within the source document (if any) for the affected link; (ii) the target document key and the structure element key within the document (if any) for the updated document; (iii) the nature of the change (i.e., addition, change, or deletion); and (iv) the date of the change. In another exemplary embodiment, the target document changes 620 portion of the target data storage 123 may also contain information to assist the source document set owner, such as hypertext links to a document comparison showing the changes. The information stored in the target document changes 620 portion of the target data storage 123 is made available to the owner of the source document set, who can use it for a variety of purposes, including determining how source documents may need to be altered because of changes in target documents.

Although the disclosed exemplary embodiments describe a fully functioning method for connecting structured document sets, the reader should understand that other equivalent exemplary embodiments exist. Since numerous modifications and variations will occur to those reviewing this disclosure, the method for connecting structured documents sets is not limited to the exact construction and operation illustrated and disclosed. Accordingly, this disclosure intends all suitable modifications and equivalents to fall within the scope of the claims.

We claim:

1. A method for connecting at least one source structured document stored on a source computer to at least one target structured document stored on a target computer, comprising:
identifying at least one link in said at least one source structured document, each link pointing to a linkable element in said at least one target structured document;
transmitting said at least one link to the target computer;
receiving at least one link change from the target computer; and
updating said at least one link based on said at least one link change.

2. The method of claim 1, wherein the identifying step further comprises:
obtaining a unique key and a citation for each link;
associating the unique key and the citation with each link; and
storing the unique key and the citation for each link on the source computer.

3. The method of claim 1, wherein the transmitting step further comprises:
transmitting a unique key and a citation with each link.

4. The method of claim 1, further comprising:
storing said at least one link on the source computer.

5. The method of claim 1, further comprising:
storing said at least one link change on the source computer.

6. The method of claim 1, wherein the source computer is a web server and the target computer is a web server.

7. The method of claim 1, wherein each link is a hypertext link.

8. The method of claim 1, wherein each source structured document includes a hierarchical organization.

9. The method of claim 1, wherein each target structured document includes a hierarchical organization.

10. The method of claim 1, wherein each link change includes:
a source document key that uniquely identifies the source structured document associated with the link affected by the link change;
a target document key that uniquely identifies the target structured document associated with the link affected by the link change;
a linkable element key that uniquely identifies the linkable element associated with the link affected by the link change;
a description of the link change; and
a date that the link change occurred.

11. The method of claim 1, wherein a change to said at least one target structured document precipitates each link change.

12. A system for connecting at least one source structured document stored on a source computer to at least one target structured document stored on a target computer, comprising:
a memory device resident in the source computer;
a processor disposed in communication with the memory device, the processor configured to:
identify at least one link in said at least one source structured document, each link pointing to a linkable element in said at least one target structured document;
transmit said at least one link to the target computer;
receive at least one link change from the target computer; and
update said at least one link based on said at least one link change.

13. The system of claim 12, wherein to identify said at least one link, the processor is further configured to:
obtain a unique key and a citation for each link;
associate the unique key and the citation with each link; and
store the unique key and the citation for each link on the source computer.

14. The system of claim 12, wherein to transmit said at least one link, the processor is further configured to:
transmit a unique key and a citation with each link.

15. The system of claim 12, wherein the processor is further configured to:
store said at least one link on the source computer.

16. The system of claim 12, wherein the processor is further configured to:
store said at least one link change on the source computer.

17. The system of claim 12, wherein the source computer is a web server and the target computer is a web server.

18. The system of claim 12, wherein each link is a hypertext link.

19. The system of claim 12, wherein each source structured document includes a hierarchical organization.

20. The system of claim 12, wherein each target structured document includes a hierarchical organization.

21. The system of claim 12, wherein each link change includes:
a source document key that uniquely identifies the source structured document associated with the link affected by the link change;
a target document key that uniquely identifies the target structured document associated with the link affected by the link change;
a linkable element key that uniquely identifies the linkable element associated with the link affected by the link change;
a description of the link change; and
a date that the link change occurred.

22. The system of claim 12, wherein a change to said at least one target structured document precipitates each link change.

23. A method for connecting at least one source structured document stored on a source computer to at least one target structured document stored on a target computer, comprising:
receiving at least one link from the source computer, each link in said at least one source structured document pointing to a linkable element in said at least one target structured document;
identifying at least one linkable element in said at least one target structured document;
associating each link with one of said at least one linkable element;
determining at least one link change based on a change to one of said at least one target structured document; and
transmitting said at least one link change to the source computer.

24. The method of claim 23, wherein the identifying step further comprises:
obtaining a unique key and a citation for each linkable element;
associating the unique key and the citation with each linkable element; and
storing the unique key and the citation for each linkable element on the target computer.

25. The method of claim 23, wherein the receiving step further comprises:
receiving a unique key and a citation with each link.

26. The method of claim 23, further comprising:
storing said at least one link on the target computer.

27. The method of claim 23, further comprising:
storing said at least one linkable element on the target computer.

28. The method of claim 23, further comprising:
storing said at least one link change on the target computer.

29. The method of claim 23, wherein the source computer is a web server and the target computer is a web server.

30. The method of claim 23, wherein each link is a hypertext link.

31. The method of claim 23, wherein each source structured document includes a hierarchical organization.

32. The method of claim 23, wherein each target structured document includes a hierarchical organization.

32. The method of claim 23, wherein each link change includes:
a source document key that uniquely identifies the source structured document associated with the link affected by the link change;
a target document key that uniquely identifies the target structured document associated with the link affected by the link change;
a linkable element key that uniquely identifies the linkable element associated with the link affected by the link change;
a description of the link change; and
a date that the link change occurred.

34. A system for connecting at least one source structured document stored on a source computer to at least one target structured document stored on a target computer, comprising:
a memory device resident in the target computer;
a processor disposed in communication with the memory device, the processor configured to:
receive at least one link from the source computer, each link in said at least one source structured document pointing to a linkable element in said at least one target structured document;
identify at least one linkable element in said at least one target structured document;
associate each link with one of said at least one linkable element;
determine at least one link change based on a change to one of said at least one target structured document; and
transmit said at least one link change to the source computer.

35. The system of claim 34, wherein to identify said at least one linkable element, the processor is further configured to:
obtain a unique key and a citation for each linkable element;
associate the unique key and the citation with each linkable element; and
store the unique key and the citation for each linkable element on the target computer.

36. The system of claim 34, wherein to receive said at least one link, the processor is further configured to:
receive a unique key and a citation with each link.

37. The system of claim 34, wherein the processor is further configured to:
store said at least one link on the target computer.

38. The system of claim 34, wherein the processor is further configured to:
store said at least one linkable element on the target computer.

39. The system of claim 34, wherein the processor is further configured to:
store said at least one link change on the target computer.

40. The system of claim 34, wherein the source computer is a web server and the target computer is a web server.

41. The system of claim 34, wherein each link is a hypertext link.

42. The system of claim 34, wherein each source structured document includes a hierarchical organization.

43. The system of claim 34, wherein each target structured document includes a hierarchical organization.

44. The system of claim 34, wherein each link change includes:
a source document key that uniquely identifies the source structured document associated with the link affected by the link change;
a target document key that uniquely identifies the target structured document associated with the link affected by the link change;
a linkable element key that uniquely identifies the linkable element associated with the link affected by the link change;
a description of the link change; and
a date that the link change occurred.

45. A system for connecting at least one source structured document stored on a source computer to at least one target structured document stored on a target computer, comprising:
a source memory device resident in the source computer;
a source processor disposed in communication with the source memory device, the source processor configured to:
identify at least one link in said at least one source structured document, each link pointing to a linkable element in said at least one target structured document;
transmit said at least one link to the target computer;
receive at least one link change from the target computer; and
update said at least one link based on said at least one link change; and
a target memory device resident in the target computer;
a target processor disposed in communication with the target memory device, the target processor configured to:
receive said at least one link from the source computer;
identify at least one linkable element in said at least one target structured document;
associate each link with one of said at least one linkable element;
determine said at least one link change based on a change to one of said at least one target structured document; and
transmit said at least one link change to the source computer.
